(19) United States
(12) Patent Application Publication
(10) Pub. No.: US 2023/0120683 A1
(43) Pub. Date: Apr. 20, 2023

(54) REMOTE MONITORING SYSTEM, DISTRIBUTION CONTROL APPARATUS, AND METHOD

(71) Applicant: NEC Corporation, Minato-ku,Tokyo (JP)

(72) Inventors: Koichi NIHEI, Tokyo (JP); Takanori IWAI, Tokyo (JP); Kosei KOBAYASHI, Tokyo (JP); Yusuke SHINOHARA, Tokyo (JP); Masayuki SAKATA, Tokyo (JP); Takashi YAMANE, Tokyo (JP)

(73) Assignee: NEC Corporation, Minato-ku,Tokyo (JP)

(21) Appl. No.: 17/910,044

(22) PCT Filed: Mar. 31, 2020
(86) PCT No.: PCT/JP2020/014944

§ 371 Date: Sep. 8, 2022

(51) Int. Cl. G06V 20/59; G06T 7/00; G06V 20/52; G06T 7/70; G06V 20/58; G06T 3/40; G06V 40/10

(52) U.S. Cl. CPC G06V 20/59; G06T 7/0002; G06V 20/52; G06T 7/70; G06V 20/584; G06T 3/40; G06V 40/10; G06T 2207/30268; G06T 2207/30232; G06T 2207/30168; G06T 2207/30261; G06T 2207/30196

(57) ABSTRACT

An image reception unit receives an internal image from a mobile object. An accident risk prediction unit predicts a risk of occurrence of an accident inside the mobile object based on the internal image and situation information indicating a situation of the mobile object. A quality determination unit determines internal image quality information indicating quality of the internal image based on a result of the predicted risk of the inside accident. A quality adjustment unit adjusts the quality of the internal image based on the internal image quality information.

### TECHNICAL FIELD

The present disclosure relates to a remote monitoring system, a distribution control apparatus, and a method.

### BACKGROUND ART

In recent years, technologies for autonomous vehicles have been attracting attention. Autonomous driving is classified into a plurality of levels, i.e., into five levels from a level 1 at which a vehicle assists the driver in driving the vehicle to a level 5 at which the vehicle travels in a completely autonomous manner. When an autonomous vehicle travels at a level 4 or higher, no driver needs to be in the vehicle. However, if something abnormal occurs without a driver in the vehicle, the vehicle may not be able to deal with the abnormal thing. In particular, even if no driver is in an automobile that carries passengers, such as a bus, ensuring safety of the passengers by taking measures is important.

As a related art, Patent Literature 1 discloses an in-vehicle apparatus for recording moving image data. In Patent Literature 1, a camera disposed in a vehicle films a situation surrounding the vehicle that is traveling. The data recording apparatus compresses moving image data at normal image quality and stores the compressed moving image data on a storage unit for normal image quality data. The data recording apparatus compresses moving image data at a level of image quality higher than the normal image quality. The data recording apparatus determines whether or not a trigger indicating an abnormal situation such as the approach of a vehicle, the approach of a human, application of sudden braking, or a shock has occurred. When occurrence of an abnormal event is determined, the data recording apparatus stores moving image data that has been filmed for a certain period of time just prior to the occurrence of the abnormal event and that is compressed at the high level of image quality on a storage unit for high image quality data.

As another related art, Patent Literature 2 discloses a monitoring apparatus designed to monitor a specific area such as an inside of an elevator and an interior room of a bus. In Patent Literature 2, a monitoring camera films the specific area. An image transmission apparatus transmits an image taken by the monitoring camera to outside. The monitoring apparatus calculates the number of people present in the specific area and a degree of imbalance between positions of the people based on the image taken by the monitoring camera. The monitoring apparatus, based on the calculated number of people and the degree of imbalance, adjusts image recording density and frequency with which the image transmission apparatus communicates information.

As another related art, Patent Literature 3 discloses a driver assistance system designed to present a photographed image of a surrounding area of a vehicle and a photographed image of an inside of the vehicle to a driver of the vehicle. The driver assistance system described in Patent Literature 3 determines whether or not a factor inhibiting safe driving is present outside the vehicle based on an image of an outside of the vehicle. The driver assistance system determines whether or not a factor inhibiting safe driving is present inside the vehicle based on an image of the inside of the vehicle. When a factor inhibiting safe driving is detected, the driver assistance system synthesizes an image of the outside of the vehicle and an image of the inside of the vehicle and displays a synthesized image to facilitate observation of the image from which the factor is detected.

As another related art, Patent Literature 4 discloses a vehicular communication apparatus designed to transmit an image taken by a surrounding monitoring camera and an image taken by an in-vehicle camera to a control center. The vehicular communication apparatus described in Patent Literature 4 identifies a vehicular situation based on information about a vehicle such as a vehicle velocity, a steering angle, and a gearshift position. The identified vehicular situation includes “moving straight ahead”, “turning right”, “turning left”, “moving backward”, “stopping to load or unload passengers”, and “abnormal event happening to passenger”. The vehicular communication apparatus determines which image is given precedence depending on the identified vehicular situation. The vehicular communication apparatus transmits a high-priority image in high resolution and at a high frame rate to the control center and transmits a low-priority image in low resolution and at a low frame rate to the control center.

### CITATION LIST

### Patent Literatures

Patent Literature 1: Japanese Unexamined Patent Application Publication No. 2013-080518

Patent Literature 2: International Patent Publication No. WO2017/212568

Patent Literature 3: Japanese Unexamined Patent Application Publication No. 2014-199546

Patent Literature 4: Japanese Unexamined Patent Application Publication No. 2020-3934

### SUMMARY OF INVENTION

### Technical Problem

In Patent Literature 1, the data recording apparatus changes a mode of recording in response to the occurrence of an abnormal event. However, the data recording apparatus in Patent Literature 1 records, after the occurrence of an abnormal event, moving image data of high image quality that has been filmed for a period of time just prior to the occurrence of the abnormal event. Thus, in a case where live images are distributed and monitored, the data recording apparatus described in Patent Literature 1 does not enable a real-time grasp of the situation before the occurrence of an abnormal event. When images recorded by the data recording apparatus are remotely monitored through a mobile network or another network, a minimum communications band required for remote monitoring cannot be acquired in some cases. In such a case, an apparatus on a remote monitoring side may not be able to acquire satisfactory information necessary for remote monitoring or remote control.

In Patent Literature 2, image quality of the image of the specific area transmitted to the outside is controlled depending on a factor such as a distribution of the people inside the specific area. Unfortunately, in Patent Literature 2, only a situation inside the specific area is taken into consideration in controlling the image quality. In Patent Literature 2, the image quality cannot be controlled in consideration of influence of an external factor on a subject to be imaged, which is necessary for remote monitoring or remote control.

In Patent Literature 3, which of the images of the inside and the outside of the vehicle to be chosen for facilitation of observation in the synthesized image is determined depending on the inside or the outside of the vehicle in which the factor inhibiting safe driving is present. Unfortunately, in Patent Literature 3, the driver assistance system determines a factor inside the vehicle inhibiting safe driving and a factor outside the vehicle inhibiting safe driving individually. In Patent Literature 3, the images of the inside and the outside of the vehicle are synthesized so as to facilitate observation of the image in which the factor inhibiting safe driving is present, and thus danger inside the vehicle according to motion of the vehicle is not taken into consideration.

In Patent Literature 4, when the identified vehicular situation is “abnormal event happening to passenger”, the image taken by the in-vehicle camera is set to high priority. Unfortunately, in Patent Literature 4, when the vehicular situation is other than “abnormal event happening to passenger”, the image taken by the in-vehicle camera does not take precedence over the image taken by the camera outside the vehicle. Hence, in Patent Literature 4 as well, the situation inside the vehicle according to motion of the vehicle cannot be known.

In view of the above-described circumstances, an object of the present disclosure is to provide a remote monitoring system, a distribution control apparatus, and a method that each enable acquisition of an image from which a situation inside a vehicle is grasped accurately according to motion of the vehicle.

### Solution to Problem

In order to achieve the above-described object, the present disclosure provides a remote monitoring system including: an image reception means for receiving an internal image of an inside of a mobile object through a network; an accident risk prediction means for predicting a risk of occurrence of an accident inside the mobile object based on the internal image and situation information indicating a situation of the mobile object; a quality determination means for determining internal image quality information indicating quality of the internal image based on a result of the predicted risk; and a quality adjustment means for adjusting the quality of the internal image based on the internal image quality information.

The present disclosure provides a distribution control apparatus including: an accident risk prediction means for predicting a risk of occurrence of an accident inside a mobile object based on situation information indicating a situation of the mobile object and an internal image of an inside, the mobile object being configured to transmit the internal image through a network and being able to adjust quality of the internal image to be transmitted; a quality determination means for determining internal image quality information indicating quality of the internal image based on a result of the predicted risk; and a quality control means for controlling the quality of the internal image based on the determined internal image quality information.

The present disclosure provides a remote monitoring method including: receiving an internal image of an inside of a mobile object through a network; predicting a risk of occurrence of an accident inside the mobile object based on the internal image and situation information indicating a situation of the mobile object; determining internal image quality information indicating quality of the internal image based on a result of the predicted risk; and adjusting the quality of the internal image based on the internal image quality information.

The present disclosure provides a distribution control method including: predicting a risk of occurrence of an accident inside a mobile object based on situation information indicating a situation of the mobile object and an internal image of an inside of the mobile object, the mobile object being configured to transmit the internal image through a network and being able to adjust quality of the internal image to be transmitted; determining internal image quality information indicating quality of the internal image based on a result of the predicted risk; and controlling the quality of the internal image based on the determined internal image quality information.

### Advantageous Effects of Invention

A remote monitoring system, a distribution control apparatus, and a method according to the present disclosure each enable acquisition of an image from which a situation inside a vehicle is grasped accurately according to motion of the vehicle.

### BRIEF DESCRIPTION OF DRAWINGS

FIG. 1 is a schematic block diagram showing a remote monitoring system according to the present disclosure.

FIG. 2 is a schematic flowchart showing an operation procedure performed by a remote monitoring system according to the present disclosure.

FIG. 3 is a block diagram showing a remote monitoring system according to a first example embodiment of the present disclosure.

FIG. 4 is a block diagram showing an example of a configuration of a mobile object.

FIG. 5 is a block diagram showing an example of a configuration of a remote monitoring apparatus.

FIG. 6 is a drawing showing a specific example of route information.

FIG. 7 is a flowchart showing an operation procedure performed by a remote monitoring system.

FIG. 8 is a drawing showing an example of a monitoring screen displayed by a monitoring screen display unit.

FIG. 9 is a drawing showing another example of a monitoring screen displayed by a monitoring screen display unit.

FIG. 10 is a drawing showing an example of an internal image in which some areas are adjusted to high quality.

FIG. 11 is a block diagram showing an example of a configuration of a computer apparatus.

### EXAMPLE EMBODIMENT

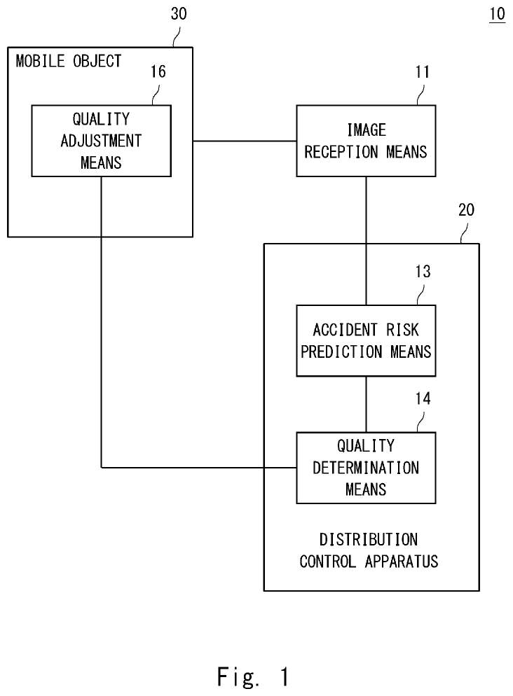

Prior to describing an example embodiment according to the present disclosure, an outline of the present disclosure will be described. FIG. 1 schematically shows a remote monitoring system according to the present disclosure. A remote monitoring system 10 includes an image reception means 11, a monitoring screen display means 12, an accident risk prediction means 13, a quality determination means 14, and a quality adjustment means 16. In the remote monitoring system 10, the accident risk prediction means 13 and the quality determination means 14 are disposed, for example, in a distribution control apparatus 20. The quality adjustment means 16 is disposed in a mobile object 30. The distribution control apparatus 20 may be disposed in the mobile object 30.

The image reception means 11 receives an internal image of an inside of the mobile object 30 through a network. The accident risk prediction means 13 predicts a risk of occurrence of an accident inside the mobile object 30 based on the internal image and situation information indicating a situation of the mobile object 30. The quality determination means 14 determines internal image quality information indicating quality of the internal image transmitted by the mobile object 30, based on a result of the predicted risk of the inside accident.

In the mobile object 30, the quality adjustment means 16 adjusts the quality of the internal quality based on the internal image quality information.

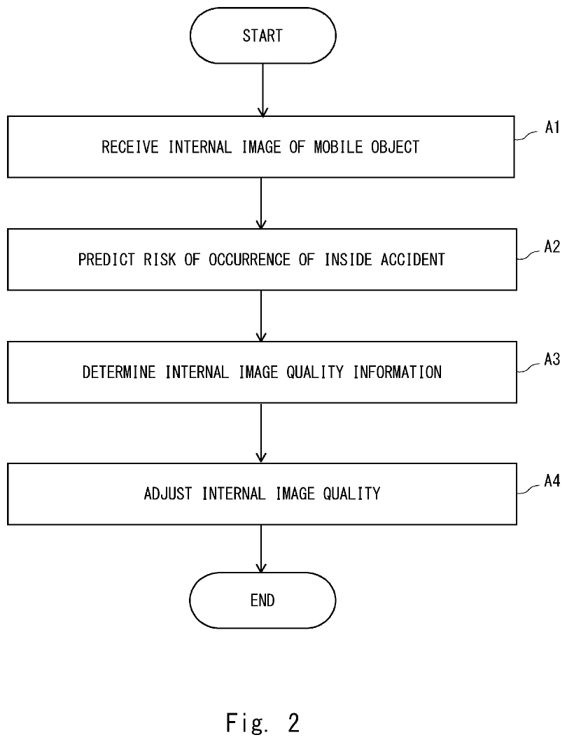

FIG. 2 schematically shows an operation procedure performed by the remote monitoring system 10. The image reception means 11 receives an internal image of the inside of the mobile object 30 through the network (Step A1). The accident risk prediction means 13 predicts a risk of occurrence of an accident inside the mobile object 30 based on the internal image of the mobile object 30 and situation information indicating the situation of the mobile object 30 (Step A2). The quality determination means 14 determines internal image quality information indicating the quality of the internal image based on a result of the predicted risk (Step A3). The quality adjustment means 16 adjusts the quality of the internal image based on the internal image quality information (Step A4).

In the present disclosure, the accident risk prediction means 13 predicts a risk of an accident inside the mobile object 30 based on the internal image and situation information about the mobile object. The quality determination means 14 determines internal image quality information based on a result of the predicted risk of the inside accident. When the result of the prediction indicates presence of a risk of an accident, the quality determination means 14 determines high quality for the quality of the internal image, for example. The quality adjustment means 16 adjusts the quality of the internal image based on the internal image quality information determined by the quality determination means 14. This process, when a risk of an accident is present inside, enables the image reception means 11 to acquire an image, according to motion of the mobile object, from which a situation inside the mobile object can be grasped accurately. This allows an observer to remotely monitor the mobile object 30 through such an image and thereby check whether danger is posed to any passenger.

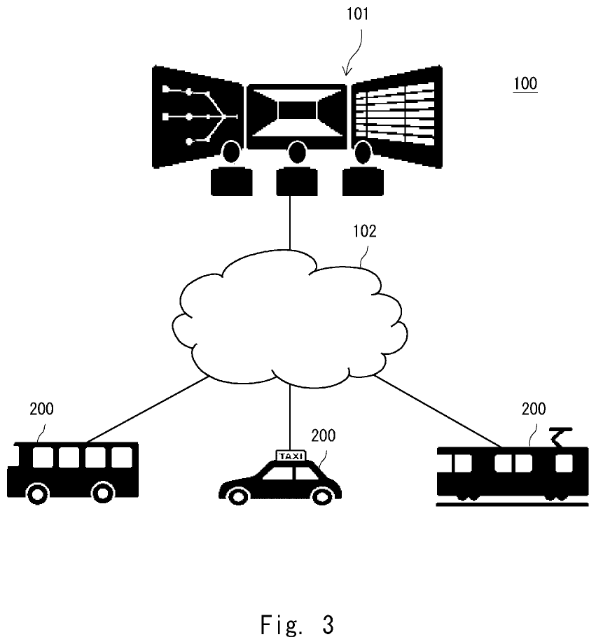

An example embodiments according to the present disclosure will be described hereinafter in detail. FIG. 3 shows a remote monitoring system according to a first example embodiment of the present disclosure. A remote monitoring system 100 includes a remote monitoring apparatus 101. The remote monitoring apparatus 101 is connected to a mobile object 200 through a network 102. The network 102 may be, for example, a network in conformity with communication line standards such as long term evolution (LTE) or may include a radio communication network such as Wi-Fi (Registered Trademark) or a fifth-generation mobile communication system. The remote monitoring system 100 corresponds to the remote monitoring system 10 shown in FIG. 1.

The mobile object 200 is constructed, for example, as a vehicle that carries passengers, such as a bus, a taxi, or a train. The mobile object 200 may be configured so as to be able to perform automated driving (autonomous driving) based on information from a sensor disposed in the mobile object. In FIG. 3, three different types of the mobile objects 200 are illustrated. However, it should be noted that the number of and types of the mobile objects 200 are not particularly limited. In the description given hereafter, the mobile object 200 is primarily a vehicle that travels on a road, such as a bus. The mobile object 200 corresponds to the mobile object 30 shown in FIG. 1.

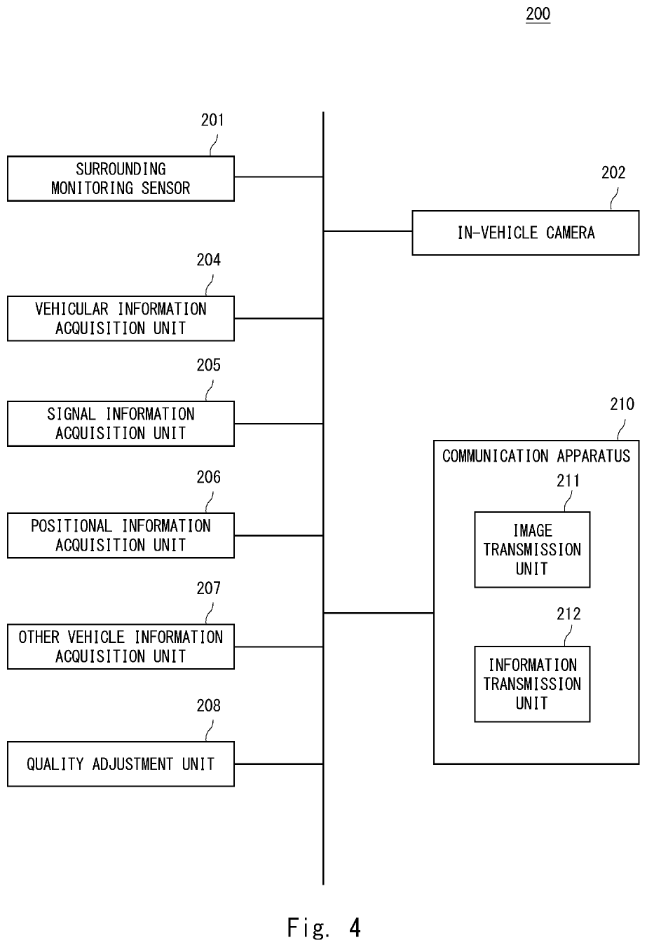

FIG. 4 shows an example of a configuration of the mobile object 200. The mobile object 200 includes a surrounding monitoring sensor 201, an in-vehicle camera 202, a vehicular information acquisition unit 204, a signal information acquisition unit 205, a positional information acquisition unit 206, an other vehicle information acquisition unit 207, a quality adjustment unit 208, and a communication apparatus 210. In the mobile object 200, these components are configured so as to be able to communicate with one another through a network such as an in-vehicle local area network (LAN) or a controller area network (CAN).

The surrounding monitoring sensor 201 is a sensor configured to monitor a situation surrounding the mobile object 200. The surrounding monitoring sensor 201, for example, includes a camera, a radar, and LiDAR (Light Detection and Ranging). The surrounding monitoring sensor 201 may, for example, include a plurality of cameras to capture images of surrounding areas on front, rear, right, and left sides of the vehicle. The in-vehicle camera 202 is a camera configured to capture an image of an inside of the mobile object 200. The in-vehicle camera 202 captures particularly an image of an area where passengers get on the vehicle. The mobile object 200 may include a plurality of the in-vehicle cameras 202.

The vehicular information acquisition unit 204 acquires various kinds of information about the mobile object 200. The vehicular information acquisition unit 204 acquires information such as a vehicle velocity, a steering angle, an opening degree of an accelerator pedal throttle, and a depression amount of a brake pedal, for example, from a vehicle sensor in the mobile object 200. The vehicular information acquisition unit 204 acquires information such as an operating status of a direction indicator and a door open/close state.

The signal information acquisition unit 205 acquires information about a state of lights of a traffic signal present in a direction in which the mobile object 200 is traveling. The signal information acquisition unit 205 may acquire information about a state of the lights of the traffic signal, for example, from a road facility such as the traffic signal through vehicle-to-infrastructure communication. Alternatively, the signal information acquisition unit 205 may analyze an image captured by a camera capturing an image of a frontward area of the vehicle to acquire information about a state of the lights of the traffic signal.

The positional information acquisition unit 206 acquires information about a position of the mobile object 200. The positional information acquisition unit 206 may acquire information about the position of the mobile object using, for example, a global navigation satellite system (GNSS). Alternatively, the positional information acquisition unit 206 may acquire the positional information from a navigation apparatus (not shown in FIG. 4) that is disposed in the mobile object 200.

The other vehicle information acquisition unit 207 acquires information about another mobile object that is present around the mobile object 200. The other vehicle information acquisition unit 207 acquires, for example, information about a distance between the mobile object 200 and a preceding vehicle traveling ahead. The distance between the mobile object 200 and the preceding vehicle traveling ahead can be acquired using, for example, sensor information output from the surrounding monitoring sensor 201.

The communication apparatus 210 is configured as an apparatus that provides radio communication between the mobile object 200 and the network 102 (refer to FIG. 3). The communication apparatus 210 includes a wireless communication antenna, a transmitter, and a receiver. The communication apparatus 210 includes a processor, memory, an input/output unit, and a bus for connecting these parts. The communication apparatus 210 includes an image transmission unit 211 and an information transmission unit 212 as logical components. Functions of the image transmission unit 211 and the information transmission unit 212 are implemented, for example, by having a microcomputer execute a control program stored in the memory.

The image transmission unit 211 transmits an image captured by the camera, which is disposed in the mobile object 200, to the remote monitoring apparatus 101 through the network 102. The image transmission unit 211 transmits an image of the inside of the mobile object 200 (an internal image) captured by the in-vehicle camera 202 to the remote monitoring apparatus 101. The image transmission unit 211 transmits an image of a surrounding area of the mobile object 200 (an external image) captured by the camera included in the surrounding monitoring sensor 201 to the remote monitoring apparatus 101.

The information transmission unit 212 transmits the various kinds of information about the mobile object 200 to the remote monitoring apparatus 101 through the network 102. The information transmission unit 212 transmits information, for example, the vehicle velocity, the operating status of the direction indicator and a door open/close state acquired by the vehicular information acquisition unit 204 to the remote monitoring apparatus 101. The information transmission unit 212 transmits information, for example, a state of the lights of a traffic signal acquired by the signal information acquisition unit 205 to the remote monitoring apparatus 101. The information transmission unit 212 transmits information about the position of the mobile object 200 acquired by the positional information acquisition unit 206 to the remote monitoring apparatus 101. The information transmission unit 212 transmits information about the distance to another vehicle acquired by the other vehicle information acquisition unit 207 to the remote monitoring apparatus 101.

The quality adjustment unit 208 adjusts quality of the image to be transmitted from the image transmission unit 211 to the remote monitoring apparatus 101. Adjusting the image quality described here involves, for example, adjusting at least part of a compression ratio, a resolution, a frame rate, or other properties of the image captured by each of the cameras and thereby adjusting an amount of data of the image to be transmitted to the remote monitoring apparatus 101 through the network 102. It is conceivable that the quality adjustment unit 208, for example, improves the quality of an important area and reduces the quality of an area other than the important area for quality adjustment. Improving the quality is, for example, action such as increasing the resolution (clearness) of the image and increasing the number of frames. The quality adjustment unit 208 adjusts particularly the quality of the internal image captured by the in-vehicle camera 202. The quality adjustment unit 208 corresponds to the quality adjustment means 16 shown in FIG. 1.

The internal image is encoded, for example, using scalable video coding (SVC). Scalable video coding is a technology for encoding a video stream by dividing the video stream into multiple layers. With scalable video coding, the bit rate and image quality can be altered by changing selected layers. Image data encoded by scalable video coding includes base layer data, first enhancement layer data, and second enhancement layer data, for example. The quality adjustment unit 208 adjusts image quality of the internal image to high, for example, by causing the base layer data, the first enhancement layer data, and the second enhancement layer data to be transmitted from the image transmission unit 211 to the remote monitoring apparatus 101. The quality adjustment unit 208 adjusts image quality of the internal image to low, for example, by causing the base layer data to be transmitted from the image transmission unit 211 to the remote monitoring apparatus 101.

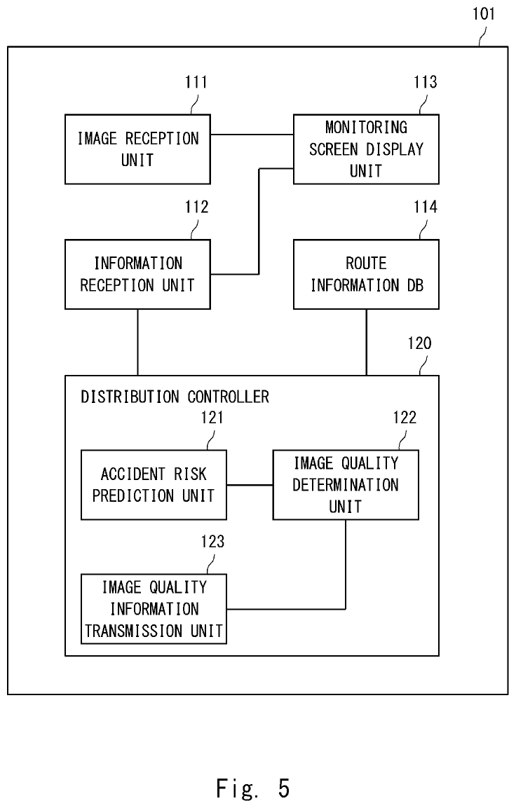

FIG. 5 shows an example of a configuration of the remote monitoring apparatus 101. The remote monitoring apparatus 101 includes an image reception unit 111, an information reception unit 112, a monitoring screen display unit 113, a route information database (DB) 114, and a distribution controller 120. The image reception unit 111 receives an image transmitted from the image transmission unit 211 of the mobile object 200 through the network. The image received by the image reception unit 111 includes an internal image captured by the in-vehicle camera 202. The image reception unit 111 corresponds to the image reception means 11 shown in FIG. 1.

The information reception unit 112 receives the various kinds of information transmitted from the information transmission unit 212 of the mobile object 200 through the network. The information reception unit 112, for example, receives information such as the vehicle velocity of the mobile object, the operating status of the direction indicator, a door open/close state, a state of the lights of a traffic signal, the positional information, and the distance to another vehicle. The monitoring screen display unit 113 displays the image, which is received by the image reception unit 111, on a display screen. The monitoring screen display unit 113 may display at least part of the various kinds of information, which is received by the information reception unit 112, on the display screen. The observer monitors operation of the mobile object 200 by observing the display screen.

The route information DB 114 holds information concerning routes operated by the mobile object 200. The route information DB 114 holds, for example, route information that serves as information indicating what intersection the mobile object 200 goes through to travel from a station to a next station. The route information DB 114 is not necessarily required to constitute a part of the remote monitoring apparatus 101, with proviso that the route information DB is accessible to the remote monitoring apparatus 101. The remote monitoring apparatus 101 may be connected to the route information DB 114, for example, through a network such as the Internet, and the remote monitoring apparatus 101 may access the route information DB 114 through the network.

The distribution controller 120 controls the quality of the internal image to be transmitted from the mobile object 200 to the remote monitoring apparatus 101. The distribution controller 120 includes an accident risk prediction unit 121, a quality determination unit 122, and a quality information transmission unit 123. The distribution controller 120 corresponds to the distribution control apparatus 20 shown in FIG. 1.

The accident risk prediction unit 121 predicts a risk of occurrence of an accident inside the mobile object 200 (an inside accident) based on situation information about the mobile object 200. The situation information about the mobile object 200 is information indicating the situation of the mobile object 200 and includes information received by the information reception unit 112 or information acquirable based on the received information. The situation information, for example, includes at least part of information acquired by the surrounding monitoring sensor 201 or information acquired by the vehicular information acquisition unit 204. The situation information may include information about the position of the mobile object and information about a state of the lights of a traffic signal. These pieces of information can be acquired from any of the positional information acquisition unit 206, the signal information acquisition unit 205, and an external apparatus. The situation information may be acquired based on an image of the surrounding area of the mobile object 200 received by the image reception unit 111. The situation information may be, for example, any of information about an object (an object such as a pedestrian, another vehicle, or a motorcycle) that is present around the mobile object 200 information about the lights of a traffic signal, and information about the distance to a surrounding object, which are determined based on the surrounding monitoring sensor 201. The accident risk prediction unit 121 determines, for example, a “high” degree of danger when the accident risk prediction unit predicts that there is a risk of an inside accident. The accident risk prediction unit 121 determines, for example, a “low” degree of danger when the accident risk prediction unit predicts no risk (a low risk) of an inside accident.

The accident risk prediction unit 121 may predict, for example, acceleration of the mobile object that is likely to arise in response to the situation information about the mobile object 200. The accident risk prediction unit 121 predicts, for example, motion of the mobile object 200 in response to the situation information about the mobile object 200 and predicts an absolute value of acceleration arising from the motion. The absolute value of the acceleration can be predicted, for example, using a table in which each motion of the mobile object is associated with an absolute value of the acceleration related to the motion or a formula for calculating the absolute value of the acceleration. The accident risk prediction unit 121 compares the predicted absolute acceleration value with a predetermined value (a threshold value) and determines a “high” degree of danger when the predicted absolute acceleration value is greater than or equal to the predetermined value. The accident risk prediction unit 121 determines a “low” degree of danger when the acceleration continues to be less than the predetermined value for a certain period of time after determining the “high” degree of danger. The accident risk prediction unit 121 corresponds to the accident risk prediction means 13 shown in FIG. 1.

For instance, the accident risk prediction unit 121 compares the positional information, which is received by the information reception unit 112 from the mobile object 200, with map information and detects that the mobile object 200 is approaching a bus stop. In this case, the accident risk prediction unit 121 predicts that the mobile object 200 is in a state in which the mobile object is going to stop at the bus stop. Based on this state, the mobile object 200 is predicted to start decelerating at a place a predetermined distance before the bus stop. The accident risk prediction unit 121 acquires a predicted value of the acceleration presented when the mobile object 200 decelerates. The accident risk prediction unit 121 predicts a risk of an inside accident caused by deceleration of a bus, such as an elderly person standing there falls down or a baby carriage moves forward. It is assumed that an absolute value of the predicted acceleration pertaining to stopping (deceleration) at the bus stop is greater than or equal to a predetermined value. In this case, the accident risk prediction unit 121 determines that the degree of danger is “high”.

When a position of the mobile object 200 coincides with a place of a bus stop, the accident risk prediction unit 121 predicts that the mobile object 200 is in a state in which the mobile object is going to leave the bus stop. Based on this state, the mobile object 200 is predicted to leave the bus stop and accelerate. The accident risk prediction unit 121 acquires a predicted value of the acceleration presented when the mobile object 200 leaves and accelerates. The accident risk prediction unit 121 predicts that the mobile object 200 is leaving, for example, when the information reception unit 112 receives information indicating that a door on the bus has closed. The accident risk prediction unit 121 may predict that the mobile object 200 is leaving when a current time reaches a point in time for leaving the bus stop. It is assumed that an absolute value of the predicted acceleration pertaining to leaving and accelerating is greater than or equal to a predetermined value. In this case, the accident risk prediction unit 121 determines that the degree of danger when the mobile object 200 is leaving is “high”.

The accident risk prediction unit 121 may predict a state in which the mobile object 200 is traveling based on positional information received by the information reception unit 112 from the mobile object 200 and route information held in the route information DB 113. The accident risk prediction unit 121 may receive route information from the mobile object 200, for example, and using the route information acquired from the mobile object 200, may predict a state in which the mobile object 200 turns right or left at an intersection. Alternatively, the accident risk prediction unit 121 may receive route information for the mobile object from an external apparatus, and using the route information acquired from the mobile object 200, may predict a state in which the mobile object 200 turns right or left at an intersection. Alternatively, using positional information acquired form the mobile object 200 as well as route information, the accident risk prediction unit may predict a state in which the mobile object 200 enters into a curved or winding road and drives through the road in a zigzag line.

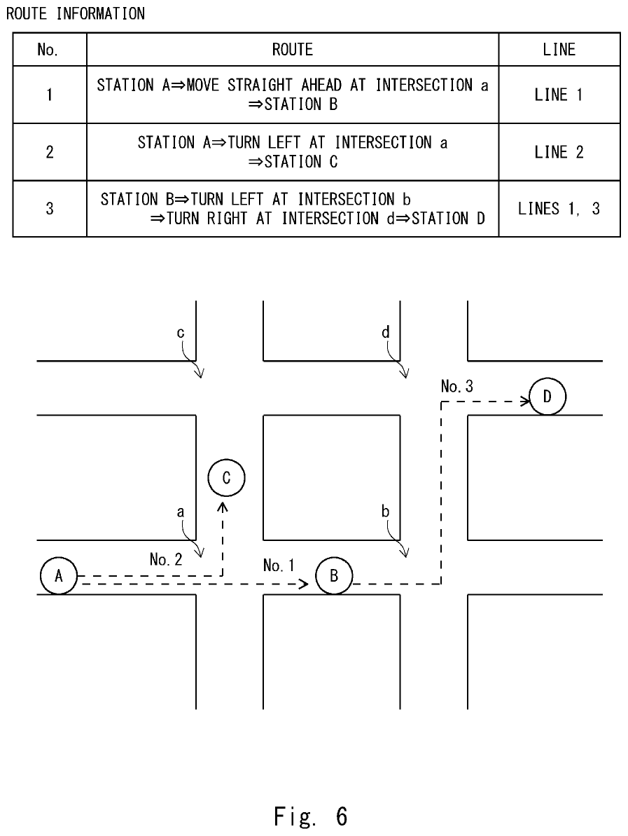

FIG. 6 shows a specific example of route information. The route information contains numbers to identify the route information, routes, and lines to which the routes are applied. In FIG. 6, No. 1 indicates a route along which the mobile object leaves a station A (a bus stop), moves straight ahead at an intersection a, and stops at a station B. No. 2 indicates a route along which the mobile object leaves the station A, turns left at the intersection a, and stops at a station C. No. 3 indicates a route along which the mobile object leaves the station B, turns left at an intersection b, then turns right at an intersection d, and stops at a station D. The No. 1 route is applied to line-1 mobile objects, the No. 2 route is applied to line-2 mobile objects, and the No. 3 route is applied to line-1 and line-3 mobile objects.

By using the route information, the accident risk prediction unit 121 is able to tell whether the mobile object 200 is going to move straight ahead or turn left at the intersection a, for example, according to the line for the mobile object and positional information. When the mobile object 200 operated under the line 1 is approaching the intersection a, the accident risk prediction unit 121 predicts, for example, that the mobile object 200 is going to turn left at the intersection a. The accident risk prediction unit 121 acquires a predicted value of the acceleration presented when the mobile object 200 turns left at the intersection. It is assumed that an absolute value of the predicted acceleration pertaining to turning left or right is greater than or equal to a predetermined value. In this case, the accident risk prediction unit 121 determines that the degree of danger is “high”.

Based on the state of the lights of a traffic signal, which is received by the information reception unit 112 from the mobile object 200, the accident risk prediction unit 121 may predict at least one of a state in which the mobile object 200 stops at the traffic signal or a state in which the mobile object 200 accelerates at the traffic signal. Rather than acquiring the state of the lights of a traffic signal from the mobile object 200, the remote monitoring apparatus 101 may acquire the state of the lights of the traffic signal from an external apparatus that controls the traffic signal. The accident risk prediction unit 121 acquires an absolute value of predicted acceleration. The predicted acceleration associated with the mobile object stopping at the traffic signal can be calculated, for example, based on the vehicle velocity of the mobile object and a distance to the traffic signal. The accident risk prediction unit 121 determines a “high” degree of danger when the accident risk prediction unit predicts a state in which the mobile object 200 stops at the traffic signal or a state in which the mobile object 200 accelerates at the traffic signal and an absolute value of the predicted acceleration associated with deceleration or acceleration is greater than or equal to a threshold value.

The accident risk prediction unit 121 may predict, based on the distance to another mobile object that is present around the mobile object 200, which is received by the information reception unit 112, a state in which the mobile object 200 is highly likely to come into contact with the other mobile object. For instance, the accident risk prediction unit 121 may predict a state in which the mobile object is highly likely to come into contact when the distance between the mobile object and the preceding mobile object is rapidly shortened. Based on this state, the mobile object 200 is predicted to act to avoid coming into contact with the other vehicle. The accident risk prediction unit 121 acquires an absolute value of predicted acceleration owing to the motion of the mobile object to avoid contact. The absolute value of the predicted acceleration can be calculated based on a difference in velocity between the mobile object 200 and the other mobile object and the distance between the mobile object 200 and the other mobile object. The accident risk prediction unit 121 determines a “high” degree of danger when the accident risk prediction unit predicts a state in which the mobile object 200 is likely to come into contact with the other mobile object and an absolute value of the predicted acceleration owing to the motion of the mobile object to avoid contact is greater than or equal to a predetermined value.

The quality determination unit 122 determines the quality of the internal image to be transmitted from the mobile object 200, based on a result predicted by the accident risk prediction unit 121. When the accident risk prediction unit 121 determines a “high” degree of danger, the quality determination unit 122 determines high quality for the quality of the internal image compared to a case in which the accident risk prediction unit 121 determines a “low” degree of danger. For instance, when the accident risk prediction unit 121 determines a “low” degree of danger, the quality determination unit 122 determines low quality (first quality) for the quality of the internal image. When the accident risk prediction unit 121 determines a “high” degree of danger, the quality determination unit 122 determines high quality (second quality) for the quality of the internal image. The quality determination unit 122 corresponds to the quality determination means 14 shown in FIG. 1.

The quality information transmission unit (quality control means) 123 transmits information for identifying the quality of the internal image (internal image quality information) determined by the quality determination unit 122 to the mobile object 200 through the network 102. In the mobile object 200, the quality adjustment unit 208 (refer to FIG. 4) receives the internal image quality information transmitted by the quality information transmission unit 123. The quality adjustment unit 208 adjusts the quality of the internal image, which the image transmission unit 211 transmits to the remote monitoring apparatus 101, based on the received internal image quality information. In the remote monitoring apparatus 101, the image reception unit 111 receives the internal image whose quality has been adjusted.

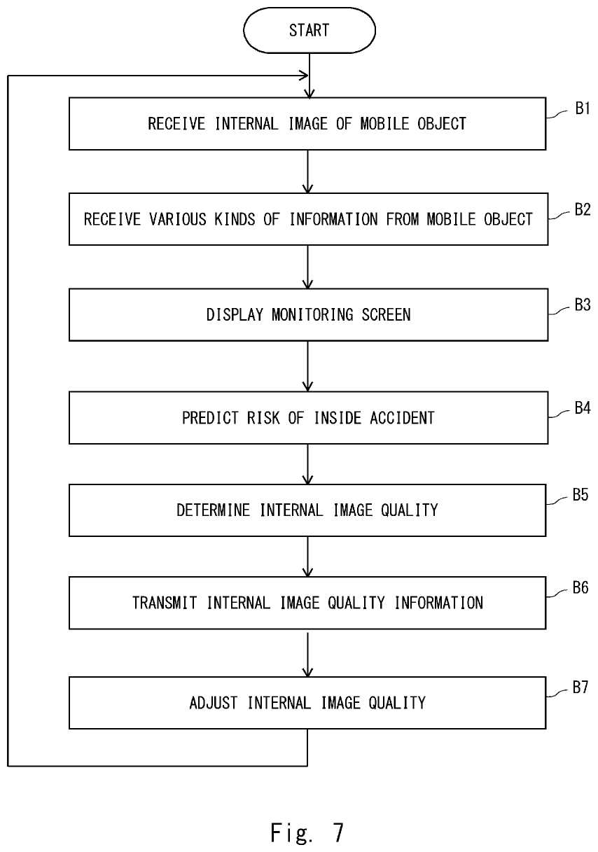

Next, an operation procedure will be described. FIG. 7 shows an operation procedure (a remote monitoring method) performed by the remote monitoring system 100. The remote monitoring method includes a distribution control method. In the mobile object 200, the image transmission unit 211 transmits an image including an internal image captured by the in-vehicle camera 202 to the remote monitoring apparatus 101 through the network 102. The information transmission unit 212 transmits the various kinds of information acquired by the vehicular information acquisition unit 204 and other parts to the remote monitoring apparatus 101 through the network 102.

In the remote monitoring apparatus 101, the image reception unit 111 receives an image transmitted from the mobile object 200 (Step B1). The information reception unit 112 receives the various kinds of information transmitted from the mobile object 200 (Step B2). The monitoring screen display unit 113 displays the image, which the image reception unit receives from the mobile object, on a monitoring screen (Step B3). In the step B3, the monitoring screen display unit 113 may display at least part of the various kinds of information, which the information reception unit receives from the mobile object 200 in the step B2, on the monitoring screen.

The accident risk prediction unit 121 predicts a risk of an inside accident occurring inside a vehicle of the mobile object 200 based on situation information about the mobile object 200 (Step B4). The quality determination unit 122 determines the quality of the internal image based on a result of the predicted inside accident risk (Step B5). When the inside accident risk is high, the quality determination unit 122, for example, determines high quality for the quality of the internal image. The quality information transmission unit 123 transmits the internal image quality information to the mobile object 200 through the network 102 (Step B6).

In the mobile object 200, the quality adjustment unit 208 receives the internal image quality information. The quality adjustment unit 208 adjusts the quality of the internal image, which is transmitted from the image transmission unit 211 to the remote monitoring apparatus 101, based on the internal image quality information (Step B7). When the internal image quality information indicates high quality, the quality adjustment unit 208, for example, adjusts the internal image to be transmitted to the remote monitoring apparatus 101 to high quality (e.g., be set (at least partly) to high resolution, high bit rate, and high frame rate). When the internal image quality information indicates low quality, the quality adjustment unit 208 adjusts the internal image to be transmitted to the remote monitoring apparatus 101 to low quality (e.g., be set (at least partly) to low resolution, low bit rate, and low frame rate).

After the quality is adjusted, the process returns to the step B1, and the image reception unit 111 receives the internal image whose quality has been adjusted. The internal image whose quality has been adjusted is displayed on the monitoring screen in the step B3. When there is a risk of an inside accident, the observer can monitor the inside of the mobile object through a high-quality internal image on the monitoring screen.

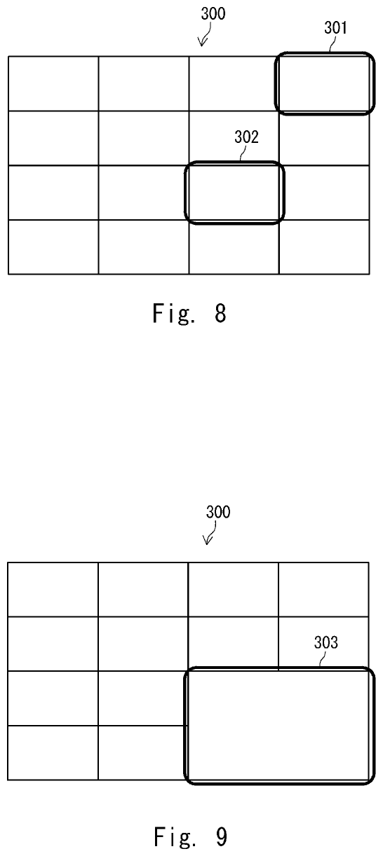

FIG. 8 shows an example of a monitoring screen displayed by the monitoring screen display unit 113. On a monitoring screen 300 shown in FIG. 8, each of areas represented by a rectangle is an area where an image received by the image reception unit from the mobile object 200 is displayed. In each area, one image may be displayed, or a plurality of images received from the same mobile object may be displayed. By observing the images displayed in the areas, the observer remotely monitors the mobile object 200.

The monitoring screen display unit 113 may display, if the accident risk prediction unit 121 determines that a mobile object is exposed to a “high” degree of danger, an area where an internal image received from the mobile object is displayed in a mode such that the area is distinguishable from any of the other areas where an internal image received by the image reception unit from another mobile object is displayed. As shown in FIG. 8, the monitoring screen display unit 113 may, for example, enclose the areas, in which an internal image of a mobile object determined as a “high” degree of danger is displayed, in frames 301 and 302 of a red or other color. In this case, by closely observing the internal image enclosed in the frames 301 and 302, the observer is able to monitor the internal image with extra care.

FIG. 9 shows another example of a monitoring screen displayed by the monitoring screen display unit 113. If the accident risk prediction unit 121 determines that a mobile object is exposed to a “high” degree of danger, the monitoring screen display unit 113, as shown in FIG. 9, may enlarge the area, in which an internal image received by the image reception unit from the mobile object is displayed, on the monitoring screen 300. The monitoring screen display unit 113 may enclose the area, in which the internal image of the mobile object determined as a “high” degree of danger is displayed, in a frame 303 of a red or other color. In this case, by observing the internal image in an enlarged view, the observer is able to monitor the inside of the mobile object 200 in detail.

In this example embodiment, the accident risk prediction unit 121 of the distribution controller 120 predicts a risk of an accident inside the mobile object 200 based on situation information about the mobile object. The quality determination unit 122 determines the quality of an internal image based on a result of the predicted inside accident risk. The quality information transmission unit 123 transmits the internal image quality information to the mobile object 200 to control the quality of the internal image to be transmitted from the mobile object 200 to the remote monitoring apparatus 101. In this way, the distribution controller 120 is able to adjust the quality (bit rate) of the internal image on a remote side in response to the predicted inside accident risk.

When the result of the predicted inside accident risk indicates a high risk of an inside accident, the quality determination unit 122 determines high quality for the quality of the internal image, for example. The quality adjustment unit 208 adjusts the quality of the internal image based on the quality determined by the quality determination unit 122. This process, when a risk of an accident is present inside the mobile object 200, enables the image reception unit 111 to acquire an image from which a situation inside the mobile object can be grasped accurately. This allows the observer to remotely monitor the mobile object 200 through such an image and thereby check whether danger is posed to any passenger in the mobile object.

Meanwhile, when the result of the predicted inside accident risk indicates a low risk of an inside accident, the quality determination unit 122 determines low quality for the quality of the internal image. The image reception unit 111 receives a low-quality internal image from the mobile object 200. In this case, the risk of occurrence of an inside accident in the mobile object 200 is low. It is thus considered that a reduction in the quality of the internal image observed by the observer does not pose any particular problem. The mobile object 200 transmits the low-quality internal image. This helps to reduce an amount of data communicated through the network 102 and produce an effect of reduced congestion in a communications band.

Next, a second example embodiment of the present disclosure will be described. A configuration of a remote monitoring system according to this example embodiment may be similar to the configuration of the remote monitoring system according to the first example embodiment shown in FIG. 3. A configuration of a mobile object 200 may be similar to the configuration of the mobile object 200 according to the first example embodiment shown in FIG. 4 and a configuration of a remote monitoring apparatus 101 may be similar to the configuration of the remote monitoring apparatus 101 according to the first example embodiment shown in FIG. 5.

In this example embodiment, a quality determination unit 122 determines the quality of an internal image based on information about an inside of the mobile object 200 in addition to a result predicted by an accident risk prediction unit 121. The quality determination unit 122, for example, acquires information about the inside of the mobile object 200 based on the internal image received by an image reception unit 111. For instance, the quality determination unit 122 analyzes the internal image to determine whether or not a passenger who is not seated is present. When there is not any passenger who is not seated, i.e., any passenger is not standing, the quality determination unit 122 determines low quality for the quality of the internal image even if the accident risk prediction unit 121 determines a “high” degree of danger.

If all the passengers in the mobile object 200 are seated, danger that any of the passengers would fall down is small. In this example embodiment, the quality of the internal image is set to low quality in such a case, and this helps to effectively reduce the amount of data communicated through the network 102. Other effects are similar to those in the first example embodiment.

A third example embodiment of the present disclosure will be described. A configuration of a remote monitoring system according to this example embodiment may be similar to the configuration of the remote monitoring system according to the first example embodiment shown in FIG. 3. A configuration of a mobile object 200 may be similar to the configuration of the mobile object 200 according to the first example embodiment shown in FIG. 4 and a configuration of a remote monitoring apparatus 101 may be similar to the configuration of the remote monitoring apparatus 101 according to the first example embodiment shown in FIG. 5. In this example embodiment, in a similar way to the second example embodiment, a quality determination unit 122 may determine the quality of an internal image based on information about an inside of the mobile object 200 in addition to a result predicted by an accident risk prediction unit 121.

In this example embodiment, the quality determination unit 122 defines an important area in the internal image based on the internal image. The important area is, for example, an area in which an object associated with an inside accident is seen in the internal image. The quality determination unit 122 may define a plurality of the important areas in the internal image. The quality determination unit 122, for example, analyzes the internal image to identify an area in which a passenger is seen out of the internal image. The quality determination unit 122 may define an area in which a passenger is seen (an area of a passenger) as an important area. The quality determination unit 122, for example, analyzes the internal image to identify an area in which a passenger who is not seated is present. The quality determination unit 122 may define an area in which a passenger not seated, i.e., a passenger who is standing, is present as an important area. The quality determination unit 122 may define an area in which a passenger associated with a high risk of accident like falling down, e.g., a child or an old person, is present as an important area.

An information reception unit 112 of the remote monitoring apparatus 101, for example, acquires a fare type such as a children's fare, a fare for the elderly, or a discount fare for the disabled from the mobile object 200 when a passenger gets on the mobile object. The quality determination unit 122 detects each passenger from the internal image and assigns a class such as children or old persons to the passenger based on the acquired fare type. The quality determination unit 122 may analyze the internal image to estimate age or another attribute of each passenger and assign a class such as children or old persons to the passenger based on a result of the estimated age or attribute. The quality determination unit 122 tracks each passenger to which a children or old persons class is assigned and thereby traces where the passenger has moved inside the vehicle of the mobile object 200. The quality determination unit 122 defines an area in which a passenger to which a children or old persons class is assigned is present as an important area.

In this example embodiment, the quality determination unit 122 determines the quality of the internal image such that quality of the important area is higher than quality of an area other than the important area in the internal image. The quality determination unit 122, for example, determines high quality for the quality of only the important area and determines low quality for the other area in the internal image. If a plurality of important areas are defined, the quality determination unit 122 may determine the quality of a specific one of the important areas even higher than the high quality for the other important area. A method that can be conceived to adjust some of the areas in the internal image to high quality includes associating the overall internal image with a base layer and associating the important area with a first enhancement layer or a second enhancement layer by scalable video coding. In this case, the important area has a high bit rate while the bit rate of the other area is set to low. This contributes to a reduction in the amount of data compared to a case in which the image is fully set to high quality.

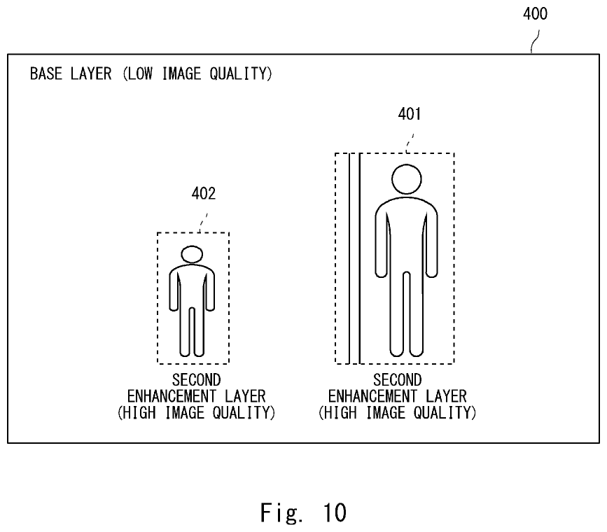

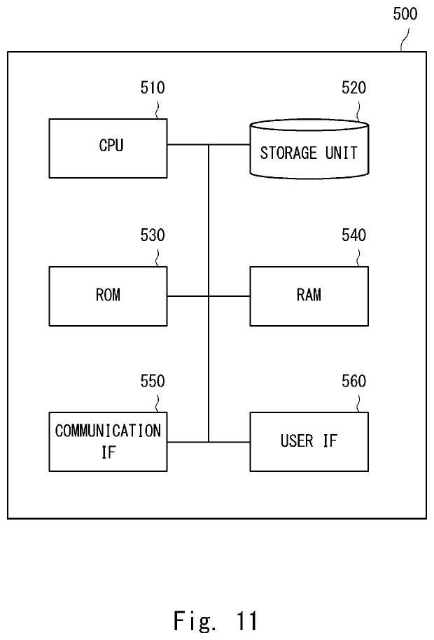

FIG. 10 shows an example of an internal image in which some areas are adjusted to high quality. In this example, two important areas 401 and 402 are defined inside an internal image 400. The important area 401 is an area corresponding to a passenger such as an adult standing near a handrail. The important area 402 is an area corresponding to a child passenger. The quality determination unit 122 determines low quality for the quality of the area other than the important areas 401 and 402, for example. The quality determination unit 122 determines high quality, which is higher in quality than the low quality, for the quality of the important areas 401 and 402, for example.

The quality adjustment unit 208 in the mobile object 200 adjusts the quality of the important areas 401 and 402 in the internal image to high quality. For instance, the quality adjustment unit 208 causes the base layer data to which the overall internal image is encoded by scalable video coding to be transmitted from the image transmission unit 211 to the remote monitoring apparatus 101. The quality adjustment unit 208 causes the first enhancement layer and the second enhancement layer data as well as the base layer data for the important areas 401 and 402 to be transmitted from the image transmission unit 211 to the remote monitoring apparatus 101. In this way, the monitoring screen display unit 113 of the remote monitoring apparatus 101 is able to display the important areas 401 and 402 in high image quality in the internal image that is adjusted to low quality overall. In this case, while the image quality of the important areas 402 and 403 is kept high, data compressibility of the other area can be increased. This helps to reduce the amount of data communicated through the network 102 compared to a case in which the image is fully set to high quality.

In this example embodiment, an important area part of the internal image is adjusted to high quality. In this way, the observer can monitor the inside of the mobile object 200 particularly the important area through a high-quality image. In this example embodiment, some of the areas in the internal image are adjusted to high quality, and this helps to reduce the amount of data communicated through the network 102 compared to a case in which the internal image is fully set to high quality. Other effects may be similar to those in the first example embodiment or the second example embodiment.

In the description given in the first example embodiment, the accident risk prediction unit 121 predicts a high inside accident risk when the acceleration of the mobile object 200 changes in an anterior-posterior direction primarily due to deceleration or acceleration. However, this should not be construed to limit the present disclosure. The accident risk prediction unit 121 may predict a high inside accident risk, for example, when the acceleration of the mobile object 200 changes in a height direction (a superior-inferior direction).

In the example embodiments described above, a person, by observing an image, monitors the mobile object for an inside accident, for example. However, in the present disclosure, the subject that determines an inside accident is not limited to persons. For instance, a remote monitoring apparatus may be equipped with a function to detect a person's falling down in response to motion or posture of the person and may determine occurrence of an inside accident using such a function. Alternatively, a remote monitoring apparatus with artificial intelligence (AI) that has learned a large number of accident images may allow the AI to monitor an internal image, and the AI may determine the occurrence of an inside accident. When the AI or something similar determines the occurrence of an inside accident, the remote monitoring apparatus may inform an observer of the inside accident.

For example, the accident risk prediction unit 121 may detect a difference in level through an image of a forward area of the mobile object 200and that is received by the image reception unit 111. In addition to detecting a difference in level from the image, the accident risk prediction unit 121 may detect a difference in level based on motion of the preceding vehicle in the superior-inferior direction. Alternatively, the accident risk prediction unit 121 may acquire information about the difference in level from map information or another source. The accident risk prediction unit 121 predicts acceleration presented when the mobile object 200 passes through a difference in level based on an amount of the level difference and the vehicle velocity of the mobile object. When an absolute value of the predicted acceleration is greater than or equal to a reference value of the acceleration in the superior-inferior direction, the accident risk prediction unit 121 predicts that there is a risk of an inside accident. When there is a predicted risk of an inside accident, the quality determination unit 122 may determine high quality for the quality of the internal image. In this case, when the mobile object 200 passes through the level difference and a body of the vehicle bounces, the observer can monitor whether any passenger is falling down through the high-quality internal image.

In the present disclosure, the remote monitoring apparatus 101 can be configured as a computer apparatus (a server apparatus). FIG. 11 shows an example of a configuration of a computer apparatus that can be used as the remote monitoring apparatus 101. A computer apparatus 500 includes a control unit (CPU: central processing unit) 510, a storage unit 520, a read only memory (ROM) 530, a random access memory (RAM) 540, a communication interface (IF: interface) 550, and a user interface 560.

The communication interface 550 is an interface for connecting the computer apparatus 500 to a communication network through wired communication means, wireless communication means, or the like. The user interface 560 includes, for example, a display unit such as a display. Further, the user interface 560 includes an input unit such as a keyboard, a mouse, and a touch panel.

The storage unit 520 is an auxiliary storage device that can hold various types of data. The storage unit 520 does not necessarily have to be a part of the computer apparatus 500, but may be an external storage device, or a cloud storage connected to the computer apparatus 500 through a network.

The ROM 530 is a non-volatile storage device. For example, a semiconductor storage device such as a flash memory having a relatively small capacity can be used for the ROM 530. A program(s) that is executed by the CPU 510 may be stored in the storage unit 520 or the ROM 530. The storage unit 520 or the ROM 530 stores, for example, various programs for implementing the function of each unit in the remote monitoring apparatus 101.

The aforementioned program can be stored and provided to the computer apparatus 500 by using any type of non-transitory computer readable media. Non-transitory computer readable media include any type of tangible storage media. Examples of non-transitory computer readable media include magnetic storage media such as floppy disks, magnetic tapes, and hard disk drives, optical magnetic storage media such as magneto-optical disks, optical disk media such as compact disc (CD) and digital versatile disk (DVD), and semiconductor memories such as mask ROM, programmable ROM (PROM), erasable PROM (EPROM), flash ROM, and RAM. Further, the program may be provided to a computer using any type of transitory computer readable media. Examples of transitory computer readable media include electric signals, optical signals, and electromagnetic waves. Transitory computer readable media can provide the program to a computer via a wired communication line such as electric wires and optical fibers or a radio communication line.

The RAM 540 is a volatile storage device. As the RAM 540, various types of semiconductor memory apparatuses such as a dynamic random access memory (DRAM) or a static random access memory (SRAM) can be used. The RAM 540 can be used as an internal buffer for temporarily storing data and the like. The CPU 510 deploys (i.e., loads) a program stored in the storage unit 520 or the ROM 530 in the RAM 540, and executes the deployed (i.e., loaded) program. The function of each unit in the remote monitoring apparatus 101 can be implemented by having the CPU 510 execute a program. The CPU 510 may include an internal buffer in which data and the like can be temporarily stored.

Although example embodiments according to the present disclosure have been described above in detail, the present disclosure is not limited to the above-described example embodiments, and the present disclosure also includes those that are obtained by making changes or modifications to the above-described example embodiments without departing from the spirit of the present disclosure.

The whole or part of the example embodiments disclosed above can be described as, but not limited to, the following Supplementary notes.

### Supplementary Note 1

A remote monitoring system including:

an image reception means for receiving an internal image of an inside of a mobile object through a network;

an accident risk prediction means for predicting a risk of occurrence of an accident inside the mobile object based on the internal image and situation information indicating a situation of the mobile object;

a quality determination means for determining internal image quality information indicating quality of the internal image based on a result of the predicted risk; and

a quality adjustment means for adjusting the quality of the internal image based on the internal image quality information.

### Supplementary Note 2

The remote monitoring system described in Supplementary note 1, in which the accident risk prediction means predicts acceleration of the mobile object in response to the situation information about the mobile object and predicts the risk based on a result of the predicted acceleration.

### Supplementary Note 3

The remote monitoring system described in Supplementary note 2, in which the accident risk prediction means compares an absolute value of the predicted acceleration with a threshold value, and predicts that there is a risk of the accident when the absolute value of the predicted acceleration is greater than or equal to the threshold value.

### Supplementary Note 4

The remote monitoring system described in any one of Supplementary notes 1 to 3, in which when the result of the predicted risk indicates presence of a risk of the accident, the quality determination means determines high quality for the quality of the internal image compared to a case in which the result of the predicted risk indicates no risk of the accident.

### Supplementary Note 5

The remote monitoring system described in any one of Supplementary notes 1 to 4, in which the quality determination means determines first quality for the quality of the internal image when the result of the predicted risk indicates no risk of the accident and determines second quality higher than the first quality for the quality of the internal image when the result of the predicted risk indicates presence of a risk of the accident.

### Supplementary Note 6

The remote monitoring system described in any one of Supplementary notes 1 to 5, in which the quality determination means further determines the quality of the internal image based on information about an inside of the mobile object.

### Supplementary Note 7

The remote monitoring system described in any one of Supplementary notes 1 to 6, in which the quality determination means further defines an important area in the internal image based on the internal image and determines the quality of the internal image such that quality of the important area is higher than quality of an area other than the important area in the internal image.

### Supplementary Note 8

The remote monitoring system described in Supplementary note 7, in which the quality determination means defines an area containing a person in the internal image as the important area.

### Supplementary Note 9

The remote monitoring system described in any one of Supplementary notes 1 to 8, in which

the situation information includes information about a position of the mobile object, and

the accident risk prediction means predicts, based on information about the position of the mobile object, at least one of a situation in which the mobile object stops at a station or a situation in which the mobile object leaves a station, and when a situation in which the mobile object stops at or leaves a station is predicted, predicts that there is a risk of occurrence of the accident.

### Supplementary Note 10

The remote monitoring system described in any one of Supplementary notes 1 to 8, in which

the situation information includes information about a position of the mobile object and route information for the mobile object, and

the accident risk prediction means predicts, based on information about the position of the mobile object and the route information for the mobile object, a situation in which the mobile object turns right or left at an intersection, and when a situation in which the mobile object turns right or left at an intersection is predicted, predicts that there is a risk of occurrence of the accident.

### Supplementary Note 11

The remote monitoring system described in any one of Supplementary notes 1 to 10, in which

the situation information includes information indicating a status of lights of a traffic signal present in a direction in which the mobile object is traveling, and

the accident risk prediction means predicts, based on information indicating the status of the lights of the traffic signal, at least one of a situation in which the mobile object stops at the traffic signal or a situation in which the mobile object accelerates, and when predicting a situation in which the mobile object stops or accelerates at the traffic signal, and when an absolute value of predicted value of acceleration associated with deceleration or acceleration is greater than or equal to a threshold value, the accident risk prediction means predicts that there is a risk of occurrence of the accident.

### Supplementary Note 12

The remote monitoring system described in any one of Supplementary notes 1 to 11, in which

the situation information includes a distance between the mobile object and another mobile object present around the mobile object, and

the accident risk prediction means predicts, based on the distance between the mobile object and the another mobile object, a situation in which the mobile object is highly likely to come into contact with the another mobile object, and when predicting a situation in which the mobile object is likely to come into contact with the another mobile object, and when an absolute value of predicted value of acceleration owing to motion to avoid the contact is greater than or equal to a threshold value, the accident risk prediction means predicts that there is a risk of occurrence of the accident.

### Supplementary Note 13

A distribution control apparatus including:

an accident risk prediction means for predicting a risk of occurrence of an accident inside a mobile object based on situation information indicating a situation of the mobile object and an internal image of an inside, the mobile object being configured to transmit the internal image through a network and being able to adjust quality of the internal image to be transmitted;

a quality determination means for determining internal image quality information indicating quality of the internal image based on a result of the predicted risk; and

a quality control means for controlling the quality of the internal image based on the determined internal image quality information.

### Supplementary Note 14

The distribution control apparatus described in Supplementary note 13, in which the accident risk prediction means predicts acceleration of the mobile object in response to the situation information about the mobile object and predicts the risk based on a result of the predicted acceleration.

### Supplementary Note 15

The distribution control apparatus described in Supplementary note 14, in which the accident risk prediction means compares an absolute value of the predicted acceleration with a threshold value, and predicts that there is a risk of the accident when the absolute value of the predicted acceleration is greater than or equal to the threshold value.

### Supplementary Note 16

The distribution control apparatus described in any one of Supplementary notes 13 to 15, in which when the result of the predicted risk indicates presence of a risk of the accident, the quality determination means determines higher quality for the quality of the internal image compared to a case in which the result of the predicted risk indicates no risk of the accident.

### Supplementary Note 17

The distribution control apparatus described in any one of Supplementary notes 13 to 16, in which the quality determination means determines first quality for the quality of the internal image when the result of the predicted risk indicates no risk of the accident and determines second quality higher than the first quality for the quality of the internal image when the result of the predicted risk indicates presence of a risk of the accident.

### Supplementary Note 18

The distribution control apparatus described in any one of Supplementary notes 13 to 17, in which the quality determination means determines the quality of the internal image based further on information about an inside of the mobile object.

### Supplementary Note 19

The distribution control apparatus described in any one of Supplementary notes 13 to 18, in which the quality determination means further defines an important area in the internal image based on the internal image and determines the quality of the internal image such that quality of the important area is higher than quality of an area other than the important area in the internal image.

### Supplementary Note 20

The distribution control apparatus described in Supplementary note 19, in which the quality determination means defines an area containing a person and being inside the internal image as the important area.

### Supplementary Note 21

A remote monitoring method including:

receiving an internal image of an inside of a mobile object through a network;

predicting a risk of occurrence of an accident inside the mobile object based on the internal image and situation information indicating a situation of the mobile object;

determining internal image quality information indicating quality of the internal image based on a result of the predicted risk; and

adjusting the quality of the internal image based on the internal image quality information.

### Supplementary Note 22

The remote monitoring method described in Supplementary note 21, in which the predicting of a risk of occurrence of the accident includes predicting acceleration of the mobile object in response to the situation information about the mobile object and predicting the risk based on a result of the predicted acceleration.

### Supplementary Note 23

The remote monitoring method described in Supplementary note 22, in which the predicting of a risk of occurrence of the accident includes comparing an absolute value of the predicted acceleration with a threshold value and predicting that there is a risk of the accident when the absolute value of the predicted acceleration is greater than or equal to the threshold value.

### Supplementary Note 24

The remote monitoring method described in any one of Supplementary notes 21 to 23, in which the determining of the internal image quality information includes determining high quality for the quality of the internal image when the result of the predicted risk indicates presence of a risk of the accident, compared to a case in which the result of the predicted risk indicates no risk of the accident.

### Supplementary Note 25

The remote monitoring method described in any one of Supplementary notes 21 to 24, in which the determining of the internal image quality information further includes determining the quality of the internal image based on information about an inside of the mobile object.

### Supplementary Note 26

The remote monitoring method described in any one of Supplementary notes 21 to 25, in which the determining of the internal image quality information includes further defining an important area in the internal image based on the internal image and determining the quality of the internal image such that quality of the important area is higher than quality of an area other than the important area in the internal image.

### Supplementary Note 27

The remote monitoring method described in Supplementary note 26, in which the determining of the internal image quality information includes defining an area containing a person in the internal image as the important area.

### Supplementary Note 28

A distribution control method including:

predicting a risk of occurrence of an accident inside a mobile object based on situation information indicating a situation of the mobile object and an internal image of an inside of the mobile object, the mobile object being configured to transmit the internal image through a network and being able to adjust quality of the internal image to be transmitted;

determining internal image quality information indicating quality of the internal image based on a result of the predicted risk; and

controlling the quality of the internal image based on the determined internal image quality information.

### Supplementary Note 29

A non-transitory computer readable medium storing a program for causing a computer to perform processes including:

predicting a risk of occurrence of an accident inside a mobile object based on situation information indicating a situation of the mobile object and an internal image of an inside of the mobile object, the mobile object being configured to transmit the internal image through a network and being able to adjust quality of the internal image to be transmitted;

determining internal image quality information indicating quality of the internal image based on a result of the predicted risk; and

controlling the quality of the internal image based on the determined internal image quality information.

### REFERENCE SIGNS LIST

10 REMOTE MONITORING SYSTEM

11 IMAGE RECEPTION MEANS

13 ACCIDENT RISK PREDICTION MEANS

14 QUALITY DETERMINATION MEANS

16 QUALITY ADJUSTMENT MEANS

20 DISTRIBUTION CONTROL APPARATUS

30 MOBILE OBJECT

100 REMOTE MONITORING SYSTEM

101 REMOTE MONITORING APPARATUS

102 NETWORK

111 IMAGE RECEPTION UNIT

112 INFORMATION RECEPTION UNIT

113 MONITORING SCREEN DISPLAY UNIT

120 DISTRIBUTION CONTROLLER

121 ACCIDENT RISK PREDICTION UNIT

122 QUALITY DETERMINATION UNIT

123 QUALITY INFORMATION TRANSMISSION UNIT

200 MOBILE OBJECT

201 SURROUNDING MONITORING SENSOR

202 IN-VEHICLE CAMERA

204 VEHICULAR INFORMATION ACQUISITION UNIT

205 SIGNAL INFORMATION ACQUISITION UNIT

206 POSITIONAL INFORMATION ACQUISITION UNIT

207 OTHER VEHICLE INFORMATION ACQUISITION UNIT

208 QUALITY ADJUSTMENT UNIT

210 COMMUNICATION APPARATUS

211 IMAGE TRANSMISSION UNIT

212 INFORMATION TRANSMISSION UNIT

What is claimed is:

1. A remote monitoring system comprising:
at least one memory storing instructions, and
at least one processor configured to execute the instructions to:
receive an internal image of an inside of a mobile object through a network;
predict a risk of occurrence of an accident inside the mobile object based on the internal image and situation information indicating a situation of the mobile object;
determine internal image quality information indicating quality of the internal image based on a result of the predicted risk; and
adjust the quality of the internal image based on the internal image quality information.

2. The remote monitoring system according to claim 1, wherein the at least one processor is configured to execute the instructions to predict acceleration of the mobile object in response to the situation information about the mobile object and predict the risk based on a result of the predicted acceleration.

3. The remote monitoring system according to claim 2, wherein the at least one processor is configured to execute the instructions to compare an absolute value of the predicted acceleration with a threshold value, and predict that there is a risk of the accident when the absolute value of the predicted acceleration is greater than or equal to the threshold value.

4. The remote monitoring system according to claim 1, wherein when the result of the predicted risk indicates presence of a risk of the accident, the at least one processor is configured to execute the instructions to determine higher quality for the quality of the internal image compared to a case in which the result of the predicted risk indicates no risk of the accident.

5. The remote monitoring system according to claim 1, wherein the at least one processor is further configured to execute the instructions to determine the quality of the internal image based on information about an inside of the mobile object.

6. The remote monitoring system according to claim 1, wherein the at least one processor is further configured to execute the instructions to define an important area in the internal image based on the internal image and determine the quality of the internal image such that quality of the important area is higher than quality of an area other than the important area in the internal image.

7. The remote monitoring system according to claim 6, wherein the at least one processor is configured to execute the instructions to define an area containing a person in the internal image as the important area.

8. The remote monitoring system according to claim 1, wherein
the situation information includes information about a position of the mobile object, and
the at least one processor is configured to execute the instructions to predict, based on information about the position of the mobile object, at least one of a situation in which the mobile object stops at a station or a situation in which the mobile object leaves a station, and when a situation in which the mobile object stops at or leaves a station is predicted, predict that there is a risk of occurrence of the accident.

9. The remote monitoring system according to claim 1, wherein
the situation information includes information about a position of the mobile object and route information for the mobile object, and
the at least one processor is configured to execute the instructions to predict, based on information about the position of the mobile object and the route information for the mobile object, a situation in which the mobile object turns right or left at an intersection, and when a situation in which the mobile object turns right or left at an intersection is predicted, predict that there is a risk of occurrence of the accident.

10. The remote monitoring system according to claim 1, wherein
the situation information includes information indicating a status of lights of a traffic signal present in a direction in which the mobile object is traveling, and
the at least one processor is configured to execute the instructions to predict, based on information indicating the status of the lights of the traffic signal, at least one of a situation in which the mobile object stops at the traffic signal or a situation in which the mobile object accelerates, and when predicting a situation in which the mobile object stops or accelerates at the traffic signal, and when an absolute value of predicted value of acceleration associated with deceleration or acceleration is greater than or equal to a threshold value, the at least one processor is configured to execute the instructions to predict that there is a risk of occurrence of the accident.

11. The remote monitoring system according to claim 1, wherein
the situation information includes a distance between the mobile object and another mobile object present around the mobile object, and
the at least one processor is configured to execute the instructions to predict, based on the distance between the mobile object and the another mobile object, a situation in which the mobile object is highly likely to come into contact with the another mobile object, and when predicting a situation in which the mobile object is likely to come into contact with the another mobile object, and when an absolute value of predicted value of acceleration owing to motion to avoid the contact is greater than or equal to a threshold value, the at least one processor is configured to execute the instructions to predict that there is a risk of occurrence of the accident.

12. A distribution control apparatus comprising:
at least one memory storing instructions, and
at least one processor configured to execute the instructions to:
predict a risk of occurrence of an accident inside a mobile object based on situation information indicating a situation of the mobile object and an internal image of an inside the mobile object, the mobile object being configured to transmit the internal image through a network and being able to adjust quality of the internal image to be transmitted;
determine internal image quality information indicating quality of the internal image based on a result of the predicted risk; and
control the quality of the internal image based on the determined internal image quality information.

13. The distribution control apparatus according to claim 12, wherein the at least one processor is configured to execute the instructions to predict acceleration of the mobile object in response to the situation information about the mobile object and predicts the risk based on a result of the predicted acceleration.

14. The distribution control apparatus according to claim 13, wherein the at least one processor is configured to execute the instructions to compare an absolute value of the predicted acceleration with a threshold value, and predict that there is a risk of the accident when the absolute value of the predicted acceleration is greater than or equal to the threshold value.

15. The distribution control apparatus according to claim 12, wherein when the result of the predicted risk indicates presence of a risk of the accident, the at least one processor is configured to execute the instructions to determine higher quality for the quality of the internal image compared to a case in which the result of the predicted risk indicates no risk of the accident.

16. The distribution control apparatus according to claim 12, wherein the at least one processor is configured to execute the instructions to determine the quality of the internal image based further on information about an inside of the mobile object.

17. The distribution control apparatus according to claim 12, wherein the at least one processor is further configured to execute the instructions to define an important area in the internal image based on the internal image and determines the quality of the internal image such that quality of the important area is higher than quality of an area other than the important area in the internal image.

18. The distribution control apparatus according to claim 17, wherein the at least one processor is configured to execute the instructions to define an area containing a person and being inside the internal image as the important area.

19. A remote monitoring method comprising:
receiving an internal image of an inside of a mobile object through a network;
predicting a risk of occurrence of an accident inside the mobile object based on the internal image and situation information indicating a situation of the mobile object;
determining internal image quality information indicating quality of the internal image based on a result of the predicted risk; and
adjusting the quality of the internal image based on the internal image quality information.

20. The remote monitoring method according to claim 19, wherein the predicting of a risk of occurrence of the accident includes predicting acceleration of the mobile object in response to the situation information about the mobile object and predicting the risk based on a result of the predicted acceleration.

21-25. (canceled)
